(19) United States
(12) Patent Application Publication
(10) Pub. No.: US 2003/0197305 A1
(43) Pub. Date: Oct. 23, 2003

(54) Method of using clays to form absorbent materials

(76) Inventor: Mike Collins, Greybull, WY (US)

Correspondence Address: ROSENTHAL & OSHA L.L.P., 1221 MCKINNEY AVENUE, SUITE 2800, HOUSTON, TX, 77010, US

(21) Appl. No.: 10/128,213

(22) Filed: Apr. 23, 2002

(51) Int. Cl. B29C 47/00; B01J 20/12

(52) U.S. Cl. 264/211; 502/407; 264/211.11

(57) ABSTRACT

In one embodiment, a method of forming an absorbent material from clay fines, which includes treating the clay fines with an additive, wetting the clay fines so as to have a moisture content of the clay fines of about 22% to 50% of the weight of the clay fines plus the weight of the additive, and extruding the treated and wetted clay fines so as to produce the absorbent material is disclosed. In a particular embodiment, at least a portion of the clay fines is a clay selected from sepiolite, saponite, hectorite, attapulgite clay, and mixtures thereof.

### BACKGROUND OF THE INVENTION

1. Field of the Invention

The invention relates generally to methods of forming absorbent materials from selected clays. More specifically, the invention relates to a method of recovering fines generated during the processing of clay materials so as to produce a suitable dross absorbing material.

2. Background Art

Pet animals such as cats, rabbits, gerbils, ferrets and the like are often trained to urinate and defecate in a particular container, which generally is designed to hold a useful volume of an absorbent substance or mixture. Properties of such an absorbent substance usually include the ability to contain a deposit of urine or feces (dross) in a small volume of the absorbent.

It is also desirable that the absorbent substance, after drying for a selected time, form an agglomerate of particles that may easily be separated from the remaining bulk of the absorbent substance using common household implements (e.g., slotted spatulas or slotted scoops). The agglomerate may then be disposed of in a sanitary and convenient manner. Because only a small portion of the absorbent substance is removed each day, the “clumping” absorbent substance is usually more economical to use than other, non-clumping absorbent substances. Non-clumping products are typically made from non-swelling or “calcined” clays, shales, or silts. The initial cost of the non-clumping substance may be less than a comparable clumping substance, but total cost is typically higher because the bulk of the non-clumping substance must be changed more often.

Absorbent substances used to form animal litter and the like are generally formed by extruding materials such as clays through a die so as to form a plurality of particles. The particles may then be treated with additives to form animal litter. For example, U.S. Pat. No. 5,452,684 issued to Elazier-Davis et al. teaches that extrusion of a smectite clay, preferably with the addition of an adhesive, may be used to form an animal litter. An embodiment of the method disclosed in the '684 patent uses a shearing device positioned against a rear face of a die plate to greatly increase the degree of shearing of the clay during the extrusion process. Adhesive is typically added to increase the “clump strength” of the animal litter when the absorbent substance is wetted with animal dross.

Moreover, the use of clumpable clay materials as dross absorbents is well described in, for example, U.S. Pat. No. 4,657,881 issued to Crampton, U.S. Pat. No. 5,129,365 issued to Hughes, and U.S. Pat. No. 6,287,550 issued to Trinh et al.

As is well known in the art, grinding or crushing (e.g., milling) clay materials to a achieve a selected range of particle size will usually produce a significant amount of undesirable “fines.” Fines comprise aggregations (often weakly bound aggregations) of colloidal clay platelets. Further, fines often comprise as much as half of a mill's output during processing. Fines, as the term is used herein, are clay particles that are generally within the range of approximately 44 microns (U.S. sieve #325) in diameter to approximately 400 microns (U.S. sieve #40) in diameter.

Fines are usually not processed further and often must be disposed of as waste. Generally, fines have properties that are inferior to those of the bulk of the mill product (e.g., the portion of the extruded clay product that is milled to the desired size range). As a result, fines are a loss source during the manufacturing of the primary absorbent product.

Therefore, it is desirable to have a method in which fines may be recovered and used to form an absorbent material suitable for use as a dross absorbent and the like.

### SUMMARY OF INVENTION

In one aspect, the present invention relates to a method of forming an absorbent material from clay fines, which includes treating the clay fines with an additive, wetting the clay fines so as to have a moisture content of the clay fines of about 22% to 50% of the weight of the clay fines plus the weight of the additive, and extruding the treated and wetted clay fines so as to produce the absorbent material.

Other aspects and advantages of the invention will be apparent from the following description and the appended claims.

### BRIEF DESCRIPTION OF DRAWINGS

FIG. 1 shows an embodiment of a processing apparatus for use with an embodiment of the present invention.

### DETAILED DESCRIPTION

In one aspect, the present invention comprises a process in which a pugmill and an extruder are used to mix fines, recovered from milling processes, with water. The moistened fines are then further processed so as to produce an absorbent material that may be used for animal litter and the like. By moistening and reprocessing the fines, desirable clay properties such as swelling, water absorption, and cohesion are regenerated. In one aspect of the invention, which is discussed in detail below, it has been determined that it is preferable to extrude the fines with selected sodium salts and/or other materials so as to improve the properties of the regenerated clays. As a result, fines may be recovered from milling operations so that the fines may be regenerated into clays suitable for use in the production of animal litter and the like. Further fines that are generated in the regeneration process may also be passed through the pugging and extrusion process repeatedly so as to produce additional useful clay material.

In an embodiment of the present invention, water is added in the pugging stage so as to form a plastic mass. In one embodiment, water content may be less than or equal to 45 weight percent of the mass. Other embodiments may include different weigh fractions of water in relation to the total mass as long as a suitable plastic mass is formed to regenerate the fines.

The wetted clay material (plastic mass) is then passed through an extruder to separate bundled aggregates and to shear groups of clay platelets such that a functional surface area of the wetted clay material is increased. It is believed that extruding aligns the clay platelets, orienting them in a parallel fashion. The result is that the rewetted, extruded, pugged clay material forms a processed absorbent material that is more effective as an absorbent and forms stronger aggregates than unprocessed clays.

The processed absorbent material produced may then be redried and recrushed to form a portion of the final product or can be used as a separate product. Accordingly, pugging and extruding fines so as to form a processed absorbent material may enhance the economic value of milling processes and of the final product by reusing what was typically considered to be waste material and, in the processing itself, increasing the beneficial properties of the clay material that forms the processed absorbent material.

In a preferred embodiment, bentonite clays, especially bentonite clays having sodium as the dominant exchange-layer ion, are used for generating absorbent material. Bentonite clay comprises smectite clays including montmorillonite, beidellite, nontronite, and mixtures thereof. Bentonite clays having sodium as a dominant exchange-layer ion are preferred in some embodiments because sodium-bentonite clays typically are capable of adsorbing greater quantities of water than other bentonite clays. Other bentonite clays may include calcium as the dominant exchange-layer ion and tend to hydrate to a lesser degree than sodium-bentonite clays. Alternatively, saponite, a trioctahedral smectite clay, may be used in some embodiments of the invention. Other embodiments may be comprised of sepiolite, hectorite, and/or attapulgite clays or mixtures of the above and mixtures of bentonite clay with one or more of the above.

In some embodiments of the invention, one or more selected sodium salts are added to the fines during the extrusion process, or during both the pugging and the extrusion processes. The addition of the one or more selected sodium salts to the extrusion and/or pugging processes increases the cohesive properties of the processed absorbent material, and typically results in a considerable increase in the absorptive properties of the clay. After extrusion and/or pugging, the processed absorbent material produced from the rewetted fines generally has improved absorptive, adsorptive, and clumping properties when compared to the parent clay.

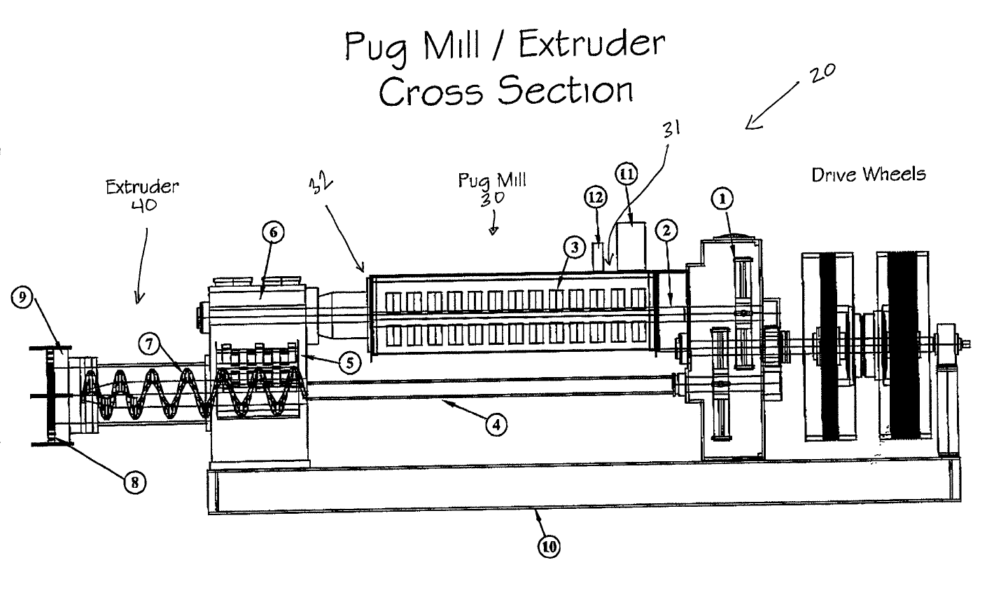

Embodiments of the invention comprise processing rewetted fines using a processing apparatus that comprises an extruder and/or a pugmill. However, it is expressly within the scope of the present invention that one or the other may be used independently. FIG. 1 shows a preferred embodiment of a processing apparatus 20 in accordance with the present invention. In FIG. 1, clay fines (not shown) enter a pug mill 30 of the processing apparatus 20 through a clay inlet 11. The pug mill 30 typically comprises at least one rotating shaft 2. A plurality of cutters 3 is affixed to the rotating shaft 2. The rotating shaft 2 and the associated cutters are operatively connected to a motor (not shown) via drive gears 1 and are usually contained within a suitable enclosure (not shown separately). Some or all of the processing apparatus may be disposed on a steel beam support 10.

Clay fines (not shown) and water (not shown) are fed into the processing apparatus 20 at the clay inlet 11 and at a water inlet 12 proximate to a feed end 31 of the processing apparatus. In one embodiment, a moisture content of the clay fines was increased from 20% to 30% by weight of dry clay. In certain embodiments, the clay fines were wetted so as to have a moisture content of about 22% to 50% of the weight of the clay fines plus the weight of the additive. The rewetted clay fines may be commingled with other selected additives within the pug mill 30. The selective additives may be added through a separate inlet (not shown) or added into the water inlet 12. The cutters 3 mix and homogenize the rewetted clay fines and selected additives to form a clay mixture. The shape and arrangement of the cutters 3 is generally selected so as to move the clay mixture from the feed end 31 of the pug mill 30 to a discharge end 32 of the pug mill 30. The discharge end 32 may contain a plurality of holes or slots (not shown separately) through which the clay mixture is forced as the cutters 3 move the clay mixture from the feed end 31 to the discharge end 32, thereby shredding or forming pellets of the clay mixture. In another embodiment, a cutter having a specialized design may be used to form the clay mixture in a selected fashion. In some embodiments, the clay mixture may be dried in a vacuum chamber 6 without being extruded.

In a preferred embodiment the clay mixture is passed from the discharge end 32 of the pug mill 30 into a vacuum chamber 6 and then through an extruder 40. The extruder typically comprises a rotatable screw 7 disposed within a cylindrical enclosure. The rotatable screw 7 is driven by an extruder drive shaft 4 that is coupled to the drive gears 1. The rotatable screw 7 comprises a discharge end 42 located proximate to a selectively located die plate 8 that is held in place by a die plate holder 9. The die plate 8 comprises a plurality of die openings (e.g., a plurality of selectively located and shaped holes (not shown)) formed in a suitable material (e.g., a substantially flat metal plate). However, while reference is made to a substantially flat “plate” it is expressly within the scope of the present invention that curved plates and similar structures may be used with various embodiments of the invention. The clay mixture passes through the extruder 40 and exits through the die openings formed in the die plate 8. After passing through the extruder 40, the clay mixture was tested as described below.

The die openings may be of any suitable shape as is known in the art. In one embodiment, the die openings comprise a plurality of circular die openings. Circular die openings in some embodiments may comprise diameters within a range of approximately 1/16 inch to approximately 1½ inches. More preferably, the die openings are within a diameter range of about ¼ to one inch and still more preferably in the diameter range of ¼ to ¾ inch. Die openings are generally arranged in a substantially regular distribution across the face of the die. The number and size of die openings may be determined by selecting a desired rate of production and/or a desired shear rate. Factors including the power available from the motors and the corresponding rotation rate of the pugmill and extruder, as well as the viscosity of the rewetted fines mixture may be used to determine the desired or maximum shear rate and production rate.

As described above, additives such as certain sodium salts may be added to the clay fines during the pugging and/or extruding process so as to achieve improved absorbent properties of the processed absorbent material (e.g., with respect to the absorption of animal dross). Additives may include, but are not limited to, sodium salts including sodium bicarbonate, sodium carbonate, sodium sulfate, sodium phosphate (including monobasic sodium phosphate, dibasic sodium phosphate, tribasic sodium phosphate, tetrasodium pyrophosphate, sodium tripolyphosphate, sodium tetraphosphate, and sodium hexametaphosphate), sodium pyrophosphate, and sodium borate. In some embodiments, the additives may be added in an amount equal to about 0.01% to about 5% of the dry weight of the clay fines.

Further, wetting agents including but not limited to anionic surfactants, cationic surfactants, nonionic surfactants, and amphoteric surfactants, and suitable mixtures thereof, when added during the pugging and/or extrusion processes, were found to add unexpected absorbent qualities to the processed absorbent material. In some embodiments, the wetting agents may be added in an amount equal to about 0.01% to about 2% of the dry weight of the clay fines. In other embodiments, the wetting agents may be may be added in an amount equal to about 0.01% to about 5% of the dry weight of the clay fines.

TABLE 1
Clump Compressive Strength after 24 Hour Aging

| | Clump | | | |
|---|---|---|---|---|
| | Compressive | | | |
| Sample | Strength, lb | Additive | | Extruded? |
| Control | 4.5 | None | | No |
| Sample 1 | 11.0 | 0.5% | NaHCO₃ | Yes |
| Repeat | 11.5 | 0.5% | NaHCO₃ | Yes |
| Sample 2 | 11.0 | 0.25% | NaHCO₃ | Yes |
| Sample 3 | 11.0 | 0.5% | NaHCO₃ | 30% |
| Sample 4 | 11.5 | 0.5% | Na₂CO₃ | 30% |
| Sample 5 | 8.0 | 0.5% | Na₄P₂O₇ | Yes |

Samples of processed absorbent material were tested to determine beneficial aspects of selected additives. A control sample of commercial clumping cat litter was purchased. Test samples were prepared by drying and crushing samples from by stockpiles ready to be milled. Each sample comprised the equivalent of 10 lb of clay with no free moisture. Moisture content was increased to 20% to 30% by weight of the dry clay by the addition of water, as discussed above. Additive concentrations are shown based on dry weight of clay. Additives were introduced to the moist clay, as noted above, prior to extrusion. In certain embodiments, the clay fines were wetted so as to have a moisture content of about 22% to 50% of the weight of the clay fines plus the weight of the additive.

Samples were extruded using a Bonnot brand extruder with a four inch diameter auger and a 5 hp electric motor. The die plate was made from ¼ inch thick mild steel and a plurality of circular openings created with a ¼ inch drillbit. The extruded, treated clay samples were dried to about 10% to 12% moisture using a laboratory oven. A 2% NaCl solution was used to simulate animal urine. A 10 ml burette containing the solution was located with its tip 3.0±0.25 inches above the sample to be tested. The burette tip was rebored to an internal diameter such that 10 ml of solution was delivered to the sample within 10 seconds. Each test sample filled a suitable pan to a depth of 1.5 to 2 inches. This was to avoid complete penetration of the simulated urine to the bottom of the pan. The pans were large enough to contain several wetted samples yet to avoid spreading of fluid from one sample to another. After the 10 ml aliquot had been delivered to a sample each sample container was set aside for 24 hours of aging at room temperature and approximately 30% relative humidity.

Table 1 shows a test of clump compressive strength after a 24 hour time period. Loose particles of the processed absorbent material were placed in a container and were wetted with either a sample of urine collected from a neutered male cat or a 2% wt. NaCl solution. Each test consisted of adding 10.0 ml of the NaCl solution or urine from a burette located with the dispensing tip 3.0±0.25 inches above the processed absorbent material to be tested. Each wetted sample was aged for 24 hours at room temperature and humidity prior to testing for compressive strength.

Compressive strength was measured by supporting previously wetted agglomerates of the processed absorbent material on two parallel edges, each approximately ⅛ inch wide and 1½ inches long. Force was applied by a one half inch wide by 1 inch long anvil located on a Chatillion electronic gage and lowered at a rate of 1.5 inches per minute by a motorized Chatillion test stand. The anvil was centered proximate a thickest point of a cross-section of each tested agglomerate.

The data in Table 1 show a surprising increase in 24-hour clump compressive strength after the addition (during pugging and extrusion) of NaHCO₃ (sodium bicarbonate), Na₂CO₃ (soda ash), and Na₄P₂O₇ (tetrasodium pyrophosphate). Samples one through four show that extrusion with each of several sodium salts more than doubled the compressive strength of the wetted and agglomerated processed absorbent material. Samples 3 and 4 were made using 30% (by weight) processed absorbent material which had been extruded with sodium bicarbonate and soda ash, respectively, blended with 70% untreated, unextruded clay. Samples 1 through 5 had approximately twice the compressive strength as did the control sample after extrusion with sodium pyrophosphate.

Although samples 3 and 4 contained only 30% (by weight) of the sodium-treated processed absorbent material and 70% untreated control clay, both samples 3 and 4 had more than twice the compressive strength of the control sample. It has been determined that processed absorbent material that is treated with one of the sodium salts during pugging and/or extrusion has an increase in inter-particulate adhesion and, accordingly, in clump compressive strength.

The additives shown in Table 1 comprise substances that are typically used in the manufacture of detergents. The additives are described generally in A. S. Davidsohn and B. Milwidsky, Synthetic Detergents, 7th edition, 1987. Chapter 3 of Synthetic Detergents discusses inorganic components used as “builders” for detergents. These include compounds capable of sequestering or precipitating ions such as calcium and magnesium from solution. Most of these compounds also assist in soil suspension. One possible mechanism of operation of such agents in the present invention is that, during the processes of pugging and/or extrusion, calcium is removed or partly removed from the exchangeable ion population of the bentonite, is sequestered, and is replaced by sodium ions from the additives. This process is generally known in the art to be a means of increasing water absorption and, therefore, swelling of bentonite clays.

Another possible mechanism of operation is that a sodium additive from the group disclosed above may increase the net-negative charge on clay platelets or aggregates. A combination of both methods may also be responsible for the unexpected results achieved through the present invention.

Moreover, other aspects of the invention include the use of complex sodium silicate additives during the pugging and/or extrusion processes. These include but are not limited to sodium metasilicate, sodium orthosilicate, and sodium sesquisilicate, all of the latter group in either the hydrated forms or the anhydrous forms. Silicate salts are typically soluble in water and are generally thought to form colloidal polyelectrolytes that impart beneficial effects to bentonite clays, including improved swelling, absorbent, and cohesive properties.

Those skilled in the art will also appreciate that water soluble polymers, including polyacrylate, water soluble derivatives of cellulose such as carboxymethyl cellulose, polyvinyl pyrrolidone, soluble derivatives of lignin such as sodium lignosulfonates and the like, and sodium silicates and the like may be added to clays so as to increase cohesive strength and to increase water absorption.

However, these additives may add a significant amount to the final cost of the processed absorbent material. Therefore, while these materials are suitable for use with various embodiments of the invention, other additives may be more cost effective.

TABLE 2
Saline Water Absorption

| Sample | Clump Weight (grams) | % Weight Decrease |
|---|---|---|
| Commercial Pet Litter | 34.1 | Control |
| Unextruded Clay “A” | 31.1 | 8.8 |
| Extruded, Treated | 29.6 | 13.2 |
| Clay “A” | | |
| Extruded, Treated | 27.8 | 18.5 |
| Clay “B” | | |

Table 2 shows the clump weight for the same volume of absorbed liquid achieved by pugging/extrusion and treatment of the clay with a sodium salt additive, as compared with clump weight of commercially available pet litter. The control clay used for the data shown in FIG. 2 is a commercially available pet litter which was wetted with 10.0 ml of a 2% NaCl solution. The clump formed weighed 34.1 grams, including the weight of the solution retained.

Clays “A” and “B” shown in Table 2 were formed in accordance with embodiments of the present invention and illustrate a noticeable decrease in clump weight when wetted with the same volume of NaCl solution used to wet the control sample. Accordingly, it is apparent from the data of Table 2 that significantly smaller amounts of processed absorbent material (e.g., clays A and B) are used in clump formation when the processed clay has been extruded and treated with a suitable sodium salt. In the samples shown in Table 2, clays A and B were extruded after the addition of a 0.5% by weight solution of sodium bicarbonate. The data in Table 2 clearly show that processed clay B was the most absorbent because it had a reduction in clump weight of 18.5% when compared to the control. Clay A also showed improved absorbency in that clay A showed a 13.2% reduction in clump weight when compared to the control. The more absorbent processed absorbent material formed according to the methods described herein may result in substantial cost savings to the consumer because less material may be required on, for example, a monthly basis.

TABLE 3
Drop Test Results

| Sample | % Weight Retained After Test |
|---|---|
| Commercial Pet Litter | 95 |
| Control (Clay “A”) | 84 |
| Extruded, Treated Clay “A” | 100 |
| Extruded, Treated Clay “B” | 98 |

Table 3 shows test results for a drop strength test that includes samples of the same control and processed absorbent materials (e.g., clays A and B) discussed above with respect to Table 2. The drop strength tests were performed one hour after wetting each sample with 10.0 ml a 2% NaCl solution. Each clump was dropped from a height of four inches above a sieve having ¾ inch openings between wires. The data illustrate the fraction of the original clump weight retained in the sieve after dropping the samples onto the sieve. Weight retention after drop-testing is desirable in that it indicates that handling of the agglomerated product for disposal will be facilitated.

The control sample of commercial pet litter retained 95% of its original weight. The untreated sample of clay A retained only 84% of its original weight. However, the treated, extruded sample of clay A retained 100% of its pre-test weight, clearly demonstrating the benefit of treatment by extrusion in the presence of sodium bicarbonate. Clay B, after extrusion in the presence of sodium bicarbonate, retained 98% of its original weight.

Clay theory suggests that one possible mechanism for improved clump strength and drop test results is that an exchange of ions occurs wherein sodium is substituted for calcium to some degree when the clay is extruded in the presence of a sodium salt. The bicarbonate anion, for example, may react with exchangeable calcium, thereby precipitating the calcium ion as calcium carbonate such that the calcium ion can no longer exert a negative effect on cohesive, adhesive, and wetting properties of the clay. Moreover, it appears that the sodium-calcium ion exchanges does not occur when the clays are mechanically mixed with sodium salts without extrusion.

It should be noted that, generally speaking, none of the sodium salts or organic surfactants used with various embodiments of the invention comprise adhesive substances. Cellulosics and starch derivatives utilized in other prior art systems to increase adhesive and cohesive properties are not used with embodiments of the present invention.

In a preferred embodiment of the present invention, clay fines comprise between about 1% to about 90% of the total weight of the absorbent material. More preferably, clay fines comprise between about 10% to about 70% of the total weight of the absorbent material. Still more preferably, clay fines comprise between about 30% to about 70% of the total weight of the absorbent material.

Advantageously, the present invention comprises a method of forming a processed absorbent material from rewetted and treated clay fines. The processed absorbent material generally exhibits improved properties for the absorption of animal dross and provides a method of using previously discarded fines elements of prior art and extrusion processes to form a substance that has properties that meet or exceed the properties of the original unextruded product. The practical use of such fines and the beneficial properties attained by treating the reprocessed fines with additives such as sodium salts generate products that may have an improved economy of both manufacture and consumption.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of forming an absorbent material from clay fines, comprising:
treating the clay fines with an additive;
wetting the clay fines so as to have a moisture content of the clay fines of about 22% to 50% of the weight of the clay fines plus the weight of the additive; and
extruding the treated and wetted clay fines so as to produce the absorbent material.

2. The method of claim 1, wherein the additive comprises a sodium salt.

3. The method of claim 2, wherein the sodium salt comprises at least one of sodium carbonate, sodium bicarbonate, sodium sulfate, sodium bisulfate, and sodium polymetaphosphate, the sodium salt in a range from about 0.05% to about 5% of the dry weight of the clay fines.

4. The method of claim 2, wherein the sodium salt comprises a sodium phosphate in a range from about 0.01% to about 5% of the dry weight of the clay fines.

5. The method of claim 4, wherein the sodium phosphate is selected from monobasic sodium phosphate, dibasic sodium phosphate, tribasic sodium phosphate, and mixtures thereof.

6. The method of claim 4, wherein the sodium phosphate is selected from tetrasodium pyrophosphate, sodium tripolyphosphate, sodium tetraphosphate, and sodium hexametaphosphate.

7. The method of claim 2, wherein the sodium salt comprises a sodium borate in a weight range of about 0.01% to about 5% of the dry weight of the clay fines.

8. The method of claim 1, wherein the additive comprises a surfactant wetting agent in a weight range of about 0.01% to about 5% of the dry weight of the clay fines.

9. The method of claim 8, wherein the surfactant wetting agent is selected from anionic, cationic, nonionic, amphoteric surfactants, and mixtures thereof.

10. The method of claim 8, wherein the surfactant wetting agent is in a weight range of about 0.01% to about 2% of the dry weight of the clay fines.

11. The method of claim 1, wherein the additive comprises a sodium silicate in a weight range of about 0.01% to about 5% of the dry weight of the clay fines.

12. The method of claim 11, wherein the sodium silicate is selected from sodium orthosilicate, sodium sesquisilicate, sodium metasilicate, and mixtures thereof.

13. The method of claim 1, wherein the additive comprises at least one selected from polyacrylates, carboxymethyl cellulose, polyvinyl pyrrolidone, sodium lignosulfonates, and mixtures thereof.

14. The method of claim 1, wherein the additive comprises a mixture of a sodium salt and a surfactant wetting agent.

15. The method of claim 1, wherein the clay fines comprise sodium bentonite.

16. The method of claim 1, wherein the clay fines comprise a mixture of sodium bentonite and calcium bentonite.

17. The method of claim 1, wherein the clay fines comprise a smectite clay.

18. The method of claim 1, wherein the clay fines comprise a mixture of smectite clays.

19. The method of claim 1, wherein the absorbent material is in a weight range from about 1% to about 90% untreated clay fines.

20. The method of claim 1, wherein the absorbent material is in a weight range from about 10% to about 70% untreated clay fines.

21. The method of claim 1, wherein the absorbent material is in a weight range from about 30% to about 70% untreated clay fines.

22. The method of claim 1, wherein at least a portion of the clay fines comprises calcium smectite.

23. The method of claim 1, wherein at least a portion of the clay fines comprises a clay selected from sepiolite, saponite, hectorite, attapulgite clay, and mixtures thereof.
